(19) United States
(12) Patent Application Publication
(10) Pub. No.: US 2025/0330917 A1
(43) Pub. Date: Oct. 23, 2025

(54) PRIORITY BASED RADIO OVERBOOKING

(71) Applicant: Telefonaktiebolaget LM Ericsson (publ), Stockholm (SE)

(72) Inventors: Erik LARSSON, Uppsala (SE); David ASTELY, Bromma (SE)

(21) Appl. No.: 18/868,292

(22) PCT Filed: Jul. 4, 2022
(86) PCT No.: PCT/SE2022/050675

§ 371 Date: Nov. 22, 2024

(51) Int. Cl. H04W 52/26; H04W 52/34; H04W 52/36

(52) U.S. Cl. CPC H04W 52/26; H04W 52/346; H04W 52/367

(57) ABSTRACT

There is provided techniques for a stream of data samples to meet a power budget. A method is performed by a network node. The method includes obtaining high-priority data samples and low-priority data samples. The high-priority data samples have higher priority than the low-priority data samples. The method includes combining all the data samples into the stream of data samples to be transmitted. Power adjustment is applied to at least some of the data samples in accordance with a maximum power threshold for the stream of data samples to meet the power budget. The power adjustment applied per data sample depends on whether the data sample is a high-priority data sample or a low-priority data sample. According to the power adjustment, the low-priority data samples are allocated lower transmission power than the high-priority data samples.

### TECHNICAL FIELD

Embodiments presented herein relate to a method, a network node, a computer program, and a computer program product for a stream of data samples to meet a power budget.

### BACKGROUND

Mobile networks are becoming increasingly more complex with several mobile network operators employing different radio access technologies on a diverse set of frequency bands. Further, the size, weight, and cost of the radio unit should be kept as small as possible without compromising on key performance indicators (KPIs). One approach is therefore to develop radio units capable of multiband operation, or even wideband operation, where one radio unit and antenna system can handle operation at several frequency bands. Further, the output power of the radio unit is a key dimensioning factor in terms of size and weight of the radio unit; more output power requires more cooling which leads to larger size and weight. By employing power pooling, that is, efficiently using the total power in a pooled manner over several carriers (and/or sectors) in a radio unit during multiband operation, the total output power can be reduced without impacting important KPIs, such as network coverage.

One way to achieve power pooling benefits is radio power overbooking. In general terms, radio power overbooking means that the carriers are configured with in total more power than what the radio unit is capable of transmitting. As an introductory illustrative example, consider a radio unit capable of multiband operation and with a maximum total output power of max 60 W. Assume that the radio unit is configured with two carriers, where each carrier can have a maximum output power of 40 W and a bandwidth of 20 MHz. This means that the carriers are typically configured with a power spectral density (PSD) of 2 W/MHz. Evidently, 40+40>60 [W], and hence if both carriers are scheduled to use more than 30 MHz (30 MHz times 2 W/MHZ=60 W), then the PSD needs to be scaled down. However, if the total utilization of both carriers is low enough (i.e., less than 30 MHZ), then the PSD target of 2 W/MHz can be kept.

Radio power overbooking is typically transparent to processing in the digital baseband unit, meaning that baseband operations, such as scheduling, will assume always having access to the configured power of the radio unit (i.e., 40 W per each 20 MHz carrier, or 2 W/MHz, in the example above). It is then up to the radio unit to ensure that the total radio capability (60 W in the example above) is never exceeded. The radio unit achieves this by scaling down the power of its carriers whenever the maximum capability of the radio unit is exceeded.

To support the operation of a radio access network, different physical signals and channels that carry different types of information, including data, control and signaling, have been defined. The importance, or sensitivity, of different channels and signals might differ. For example, best-effort data (carried in the downlink on the physical downlink shared channel, PDSCH) is subject to both lower-and higher-layer retransmissions and is therefore rather robust, whilst cell-defining signals such as synchronization signal block (SSB) signals (where each SSB comprises primary synchronization signal (PSS), secondary synchronization signal (SSS), physical broadcast channel (PBCH) and demodulation reference signal (DMRS)) are essential for maintaining network connection and for performing mobility and traffic handling.

Taking the SSB as an example, the transmit power of the SSB is typically used to determine whether a user equipment (UE) can connect to a cell, and furthermore to which cell the UE preferably should be connected to. The transmit power of the SSB is thus important for coverage and mobility handling but also in the general case for traffic management. This is since the network may use measurements made by the UE on the SSB to determine which cell the UE is to connect to not only from a radio propagation perspective but also taking the load of different cells into account. The mobile network operator might therefore dimension the PSD of the SSB to match the existing site grid.

The different physical channels and signal are mapped to the so-called time-frequency resource grid, where different channels/signals can be time and/or frequency multiplexed.

The fronthaul communication interface between the digital baseband unit and the radio unit in a conventional network node typically runs on fiber and is referred to as the common public radio interface (CPRI). Time-domain in-phase and quadrature (IQ) samples are conveyed per radio-branch and carrier from the digital baseband unit to the radio unit (and wise versa). Hence, the radio unit is provided with time-domain signal(s) and has no knowledge of the frequency-domain content, and consequently, different parts of the frequency domain cannot be straightforwardly power scaled differently in the radio unit. This implies that different parts of the frequency domain cannot be straightforwardly power scaled differently in the radio unit. One shortcoming of power overbooking is therefore that there is no guarantee that the coverage for the different cells is not changed. One consequence of this is that essential signals such as SSB and in the general case also low latency and reliable communications services need to be overprovisioned (in terms of bandwidth and/or power) for these signals to be reliably received also in the case the signal power of these signals is scaled down in the radio unit. In turn, this increases the resource usage.

### SUMMARY

An object of embodiments herein is to address the above issues by providing efficient radio power overbooking that minimizes, or at least reduces, the impact of the power overbooking on signals of importance.

According to a first aspect there is presented a method for a stream of data samples to meet a power budget. The method is performed by a network node. The method comprises obtaining high-priority data samples and low-priority data samples. The high-priority data samples have higher priority than the low-priority data samples. The method comprises combining all the data samples into the stream of data samples to be transmitted. Power adjustment is applied to at least some of the data samples in accordance with a maximum power threshold for the stream of data samples to meet the power budget. The power adjustment applied per data sample depends on whether the data sample is a high-priority data sample or a low-priority data sample. According to the power adjustment, the low-priority data samples are allocated lower transmission power than the high-priority data samples.

According to a second aspect there is presented a network node for a stream of data samples to meet a power budget. The network node comprises processing circuitry. The processing circuitry is configured to cause the network node to obtain high-priority data samples and low-priority data samples. The high-priority data samples have higher priority than the low-priority data samples. The processing circuitry is configured to cause the network node to combine all the data samples into the stream of data samples to be transmitted. Power adjustment is applied to at least some of the data samples in accordance with a maximum power threshold for the stream of data samples to meet the power budget. The power adjustment applied per data sample depends on whether the data sample is a high-priority data sample or a low-priority data sample. According to the power adjustment, the low-priority data samples are allocated lower transmission power than the high-priority data samples.

According to a third aspect there is presented a network node for a stream of data samples to meet a power budget. The network node comprises an obtain module configured to obtain high-priority data samples and low-priority data samples. The high-priority data samples have higher priority than the low-priority data samples. The network node comprises a combine module configured to combine all the data samples into the stream of data samples to be transmitted. Power adjustment is applied to at least some of the data samples in accordance with a maximum power threshold for the stream of data samples to meet the power budget. The power adjustment applied per data sample depends on whether the data sample is a high-priority data sample or a low-priority data sample. According to the power adjustment, the low-priority data samples are allocated lower transmission power than the high-priority data samples.

According to a fourth aspect there is presented a computer program for a stream of data samples to meet a power budget, the computer program comprising computer program code which, when run on a network node, causes the network node to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient radio power overbooking that minimizes, or at least reduces, the impact of the power overbooking on signals of importance.

Advantageously, these aspects guarantee a fixed PSD target to be kept for essential signals/channels.

Advantageously, these aspects ensure that radio power overbooking can be used without negatively impacting essential network information, such as cell defining signals or signals carrying prioritized communication services.

Advantageously, radio power overbooking can be used without jeopardizing network coverage, thereby providing robustness.

Advantageously, these aspects enable mobile network operators to make a trade-off between required CPRI capacity and the importance of protecting essential network information, if the combining of the signals is performed in the radio unit and a time domain CPRI interface is used between the digital baseband unit and the radio unit. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2 and 6 are flowcharts of methods according to embodiments;

FIGS. 3 and 4 schematically illustrate network nodes according to an example and according to an embodiment;

FIG. 5 schematically illustrates a time/frequency grid and a separation into high and low priority signals according to an embodiment;

FIG. 7 is a schematic diagram showing functional units of a network node according to an embodiment;

FIG. 8 is a schematic diagram showing functional modules of a network node according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

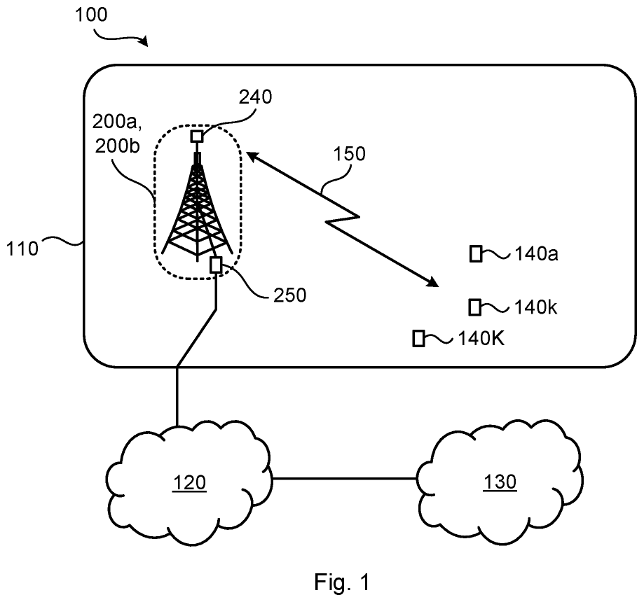

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, a sixth generation (6G) telecommunications, or any evolvement or combination thereof, and support any third generation partnership project (3GPP) telecommunications standard, where applicable. The communication network 100 comprises a network node 200a, 200b configured to provide network access to user equipment 140a, 140k, 140K, over wireless links 150 in a (radio) access network 110. The (radio) access network 110 is operatively connected to a core network 120. The core network 120 is in turn operatively connected to a service network 130, such as the Internet. The user equipment 140a: 140K are thereby enabled to, via the network node 200a, 200b, access services of, and exchange data with, the service network 130. The network node 200a, 200b comprises a radio unit 240 and a digital baseband unit 250. Examples of network nodes 200a, 200b are radio access network nodes, radio base stations, base transceiver stations, Node Bs, evolved Node Bs, gNBs, access points, and backhaul nodes. Examples of user equipment 140a:140K are terminal devices, wireless devices, mobile stations, mobile phones, handsets, wireless local loop phones, smartphones, laptop computers, tablet computers, network equipped sensors, network equipped vehicles, customer-premises equipment, and so-called Internet of Things devices.

As noted above, the radio unit is provided with time-domain signals, one for each carrier. The signals are combined in the radio unit. However, the radio unit has no knowledge of the frequency-domain content of each signal, and consequently, different parts of the frequency domain of each signal cannot be straightforwardly power adjusted differently in the radio unit.

In further detail, the radio unit obtains time-domain signal(s) from the digital baseband unit and has no, or very limited, information of the frequency-domain content of the signal(s). Consequently, different parts of the frequency domain cannot be straightforwardly power scaled differently in the radio unit. Even if the radio unit could transform the time-domain signals into frequency-domain signals, the radio unit would not have any information of how to prioritize different frequency parts in terms of power-adjusting. Furthermore, the radio unit has no information of any potential priority between the different time-domain signals, hence the different time-domain signals are typically treated with equal priority, e.g., all signals are scaled equally.

With radio power overbooking the radio unit thus blindly reduces the power of all transmitted signals/channel on all carriers. Hence, when using radio power overbooking, it cannot be guaranteed that the experienced PSD meets the configured target. Whilst this is typically not critical for best effort type of data traffic (carried on the PDSCH), it can be an issue for control channels and for cell dimensioning signals, such as the SSB. For example, a too low SSB quality, because of radio power overbooking downscaling of the PSD, will hence have a negative impact on the network coverage of the corresponding cell. Furthermore, as the digital baseband unit is unaware of how, or even if, the radio unit scales the PSD, the quality of the SSB becomes non-controllable, or at least non-predictable, from a baseband perspective. This can have a negative impact on, e.g., mobility and traffic handling.

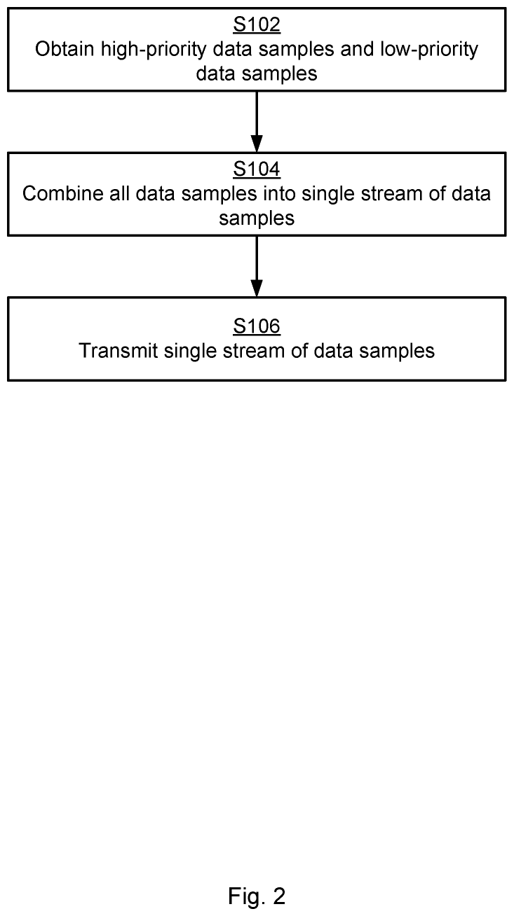

FIG. 2 is a flowchart illustrating embodiments of methods for a stream of data samples to meet a power budget. The methods are performed by the network node 200a, 200b. The methods are advantageously provided as computer programs 920.

The basic principle is to introduce a distinction between physical channels or signals (as represented by low-priority data samples) that can be power-adjusted and physical channels or signals (as represented by high-priority data samples) that should preferably not be power-adjusted. In this respect, digital baseband processing (e.g. implemented in the digital baseband unit) might generate several signal parts, or streams, for each carrier, radio branch, or port, and each signal part (as represented by data samples) can have either a high priority or a low priority (or an intermediate priority as will be disclosed below).

S102: The network node 200a, 200b obtains high-priority data samples and low-priority data samples. The high-priority data samples have higher priority than the low-priority data samples.

Then, power adjustments for the different signal parts are performed (e.g. in the radio unit or in the digital baseband unit) based on the associated priorities of the data samples and the signal powers such that the total power, i.e. the sum of all power adjusted signals, does not exceed the limit of the radio unit.

S104: The network node 200a, 200b combines all the data samples into the stream of data samples to be transmitted. Power adjustment is applied to at least some of the data samples in accordance with a maximum power threshold for the stream of data samples to meet the power budget. The power adjustment applied per data sample depends on whether the data sample is a high-priority data sample or a low-priority data sample. According to the power adjustment, the low-priority data samples are allocated lower transmission power than the high-priority data samples.

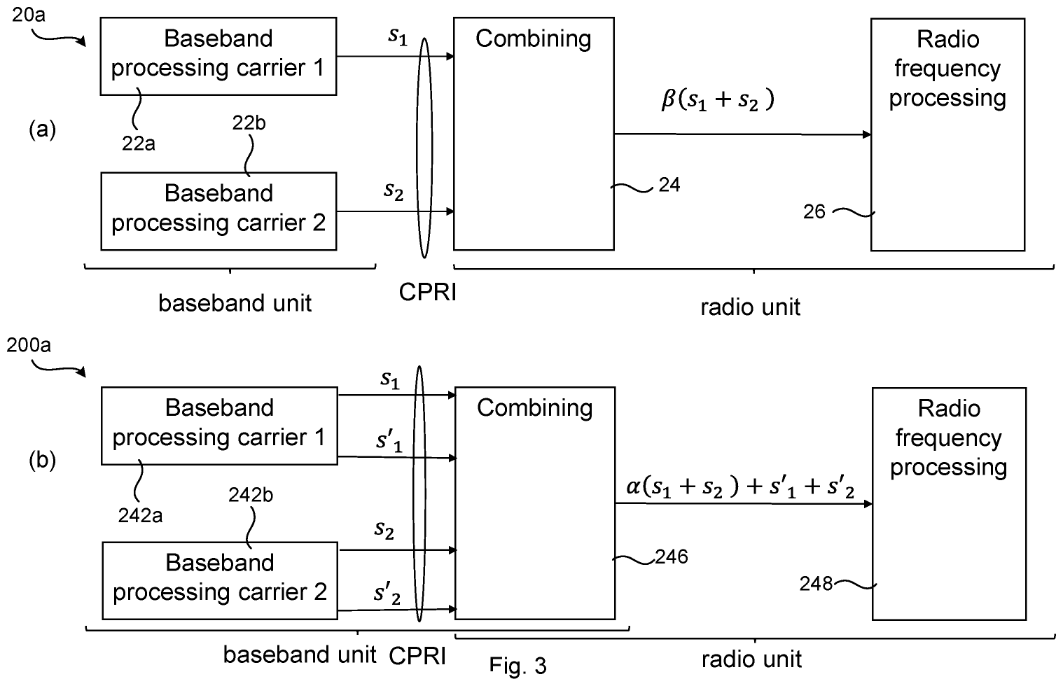

In FIG. 3 is given a first comparison between a reference network node 20a (in FIG. 3 (a)) and a network node 200a (in FIG. 3(b)) according to embodiments. In both network nodes 20a, 200a, signals from two carriers 22a, 22b, 242a, 242b are processed by a digital baseband unit and sent over a CPRI interface to a radio unit. The radio unit combines the signals and applies power adjustment in combining circuitry 24. 246 before subjecting the thus combined and power-adjusted signal to radio frequency processing circuitry 26, 248.

Focusing first on FIG. 3(a), according to the reference network node 20a, for the case with two carriers, the digital baseband unit generates a single stream per carrier that is conveyed to the radio unit. The radio unit will then receive two streams s₁ and s₂ where sk is the signal for carrier k, and form the signal to be transmitted by first summing all streams, and then controlling that the transmit power of the sum signal does not exceed the maximum power of the radio uni. This is illustrated by forming s=β(s₁+s₂), where s is the resulting signal, and β ensures that total power of s does not exceed the maximum power of the radio unit. The multiplication with the scale factor β thus represents the radio power overbooking power adjustment and that all streams, here both s₁ and s₂, are summed and that they are scaled in the same way.

Focusing next on FIG. 3(b), according to the network node 200a, the digital baseband unit will generate two streams per carrier (s₁ and s′₁ for carrier 1, and s₂ and s′₂ for carrier 2) instead of a single stream per carrier, where one stream per carrier (s′₁ for carrier 1, and s′₂ for carrier 2) corresponds to signals that should preferably not be power scaled (for example representing high-priority signals) and the other stream (s₁ for carrier 1, and s₂ for carrier 2) corresponds to signals that could be power scaled (for example representing low priority signals). The radio unit will then receive two streams, corresponding to low and high priority signals per carrier, instead of one stream per each carrier. For the network node 200a in FIG. 3(b), the power adjustment can be realized by forming s=α(s₁+s₂)+s′₁+s′₂, where power adjustment thus only is applied to the low priority signals. The combining and radio power overbooking power adjustment can in this case thus then be performed differently for the high-priority and low-priority streams, for example so that the configured power (i.e., no power adjustment) can be used for the high-priority signals. The relative power of the low priority signals as compared to the high priority signals may however be lower in the combined signals as compared to before the combiner, (i.e., α<1) if the power needs to be reduced in order to not exceed the maximum power of the radio unit. That is, in this example the radio overbooking power scales solely the low priority stream if needed.

In FIG. 4 is given a second comparison between a reference network node 20b (in FIG. 4(a)) and a network node 200b (in FIG. 4(b)) according to embodiments. In both network nodes 20b, 200b, signals from two carriers 22a, 22b, 242a, 242b, where each carrier has four radio branches, are processed by a digital baseband unit and sent over a CPRI interface to a radio unit. The radio unit combines the signals and applies power adjustment in combining circuitry 24, 246 before subjecting the thus combined and power-scaled signal to radio frequency processing circuitry 26, 248.

Focusing first on FIG. 4(a), according to the reference network node 20b, the digital baseband unit generates four streams per carrier, i.e., one per radio branch, that are conveyed to the radio unit. The radio unit will then receive the streams s₁₁, s₁₂, s₁₃, s₁₄, s₂₁, s₂₂, s₂₃, and s₄₂, where skp is the data stream associated with carrier k and radio branch p, and form the signal to be transmitted by first summing the streams per radio branch (i.e., by forming s₁ₚ+s₂ₚ for all radio branches p), and then controlling that the transmit power of the sum signal per each radio branch does not exceed the maximum power of the radio unit (per radio branch, or port), i.e., by forming sp=βₚ(s₁ₚ+s₂ₚ), where sₚ is the resulting signal for radio branch p, and βₚ ensures that total power of sₚ does not exceed the maximum power for radio branch p of the radio unit. The multiplication with the scale factors βₚ thus represents the radio power overbooking transmit power adjustment and that all streams associated with radio branch p are summed and that they are scaled in the same way.

Focusing next on FIG. 4(b), according to the network node 200b, the digital baseband unit will generate eight streams per carrier k; one stream of high-priority samples (s′ₖ₁, s′ₖ₂, s′ₖ₃, s′ₖ₄) per each of the four radio branches and one stream of low-priority samples (sₖ₁, sₖ₂, sₖ₃, Sₖ₄) per each of the four radio branches. The radio unit will then receive eight streams, corresponding to low and high priority signals per carrier, instead of four streams per each carrier. In total for the case with two carriers, 16 streams are received. For the network node 200b in FIG. 4(b), the per carrier and per radio branch power adjustment can be realized by forming sₚ=αₚ(s₁ₚ+s₂ₚ)+s′₁ₚ+s′₂ₚ, where power adjustment thus only is applied to the low priority signals per each radio branch p. The combining and radio overbooking power adjustment can then be performed differently for the high-priority and low-priority streams, for example so that the configured power (i.e., no power adjustment) can be used for the high-priority signals. The relative power of the low priority signals as compared to the high priority signals may however be lower in the combined signals as compared to before the combiner, (i.e., αₚ<1 for all p) if the power needs to be reduced in order to not exceed the maximum power of the radio unit. That is, in this example the radio overbooking power scales solely the low priority stream if needed.

Whilst FIG. 3(b) and FIG. 4(b) only illustrate two embodiments of the present inventive concept, general principles, as well as further embodiments, aspects, and examples, of techniques for a stream of data samples to meet a power budget will be disclosed next.

Once the data samples have been combined and power adjustment has been applied, and possibly after further processing, the stream of data samples is transmitted over the air. Hence, in some embodiments, the network node 200a, 200b is configured to perform (optional) step S106:

S106: The network node 200a, 200b transmits the stream of data samples over the air.

There may be different examples of signals represented by the high-priority data samples and the low-priority data samples, respectively. In some non-limiting examples, the high-priority data samples represent a reference signal (such as a reference signal used for mobility measurements or other type of reference signal used for other purposes) or a control signal, and the low-priority data samples represent a user data signal.

There might be different ways in which the power adjustment is performed.

In some aspects, the power adjustment is performed as absolute scaling of each signal or relative scaling between different signals and/or absolute or relative scaling of signals over time. In particular, in some embodiments, according to the power adjustment, the transmission power of the low-priority data samples is either adjusted independent from, or relative to, adjustment of the transmission power of the high-priority data samples. Further, in some embodiments, the high-priority data samples and the low-priority data samples are obtained per timeslot, wherein all the data samples are combined per timeslot to the stream of data samples to be transmitted. Then, according to the power adjustment, how much power adjustment that is applied per data sample can be either absolute over time or adapted per timeslot.

In some aspects, applying the power adjustment involves first scaling the data samples according to priorities of the data samples and then adjusting the power of the data samples as scaled. That is, in some embodiments, the power adjustment is applied by: applying power reduction to the low-priority data samples and/or applying power increase to the high-priority data samples, combining all the data samples to the stream of data samples, and adjusting transmission power of the stream of data samples in accordance with the maximum power threshold.

In other aspects, applying the power adjustment takes the priorities into account (without any prior scaling). That is, in some embodiments, the power adjustment is applied by: associating the low-priority data samples with a low-priority indicator and/or associating the high-priority data samples with a high-priority indicator, combining all the data samples to the stream of data samples, and adjusting transmission power of the stream of data samples in accordance with the maximum power threshold, wherein the low-priority indicator impacts adjusting the transmission power of the low-priority data samples, and wherein the high-priority indicator impacts adjusting the transmission power of the high-priority data samples.

There might be different ways to provide, realize, or implement, the priorities, i.e., the low-priority indicator and the high-priority indicator. In some aspects, the priorities are provided as rules, determining how to handle each priority when the power adjustment is applied. According to a first example, “priority high” implies that the associated data stream should not be power-adjusted, and “priority low” implies that the associated data stream can be arbitrarily power adjusted. According to a second example, “priority high” implies that the associated data stream should not be power-scaled, “priority medium” implies that the associated data stream can be power-scaled to a first threshold (such as in the order of 2 dB), and “priority low” implies that the associated data stream can be arbitrarily power scaled.

As an alternative, the priorities could be provided as weight factors, determining how the data streams should be power-scaled relative to each other. As an illustrative example, assuming up to three streams of data samples (denoted “stream 1”, “stream 2” and “stream 3”) per carrier with associated priorities (or weights) 0, 0.3 and 0.7 (where thus the sum of weights equals 1), this could mean that the data samples of “stream 1” are not to be power-scaled, and that the data samples of “stream 2” and “stream 3” are to be scaled according to 0.3 α and 0.7 α, respectively, where a is a constant that ensures that total power after scaling does not exceed the capability of the radio unit. Hence, in some embodiments, the low-priority indicator and the high-priority indicator are provided as weight factors or scaling factors.

As in the foregoing example, there might be more than two streams of data samples. That is, in some embodiments, also intermediate-priority data samples are obtained, where the intermediate-priority data samples also are combined into the stream of data samples to be transmitted. The intermediate-priority data samples have lower priority than the high-priority data samples but have higher priority than the low-priority data samples. According to the power adjustment, the intermediate-priority data samples are allocated lower transmission power than the high-priority data samples but higher transmission power than the low-priority data samples.

Further, different power-scaling intervals might be handled differently. For example, consider the case with two different priorities. Then, if the total power-scaling is below 2 dB (as an example), and the data samples of the stream with the highest priority are not power-scaled, this causes the data samples of the stream with lowest priority to be subject to all the power-scaling. However, if the total power-scaling exceeds a predetermined level, say, 2 dB, then also the data samples of the stream with the highest priority might also be power-scaled to ensure that the data samples of the stream with the lowest priority do not get too low power (or even zero power). Hence, in the extreme case it could otherwise be the case that with too aggressive radio power overbooking the data samples of the stream with the lowest priority would get zero power. Therefore, in some embodiments, according to the power adjustment, the transmission power of the low-priority data samples is at most reduced to a predetermined threshold value, and wherein also the transmission power of the high-priority data samples is reduced for the stream of data samples to meet the power budget. Still further, a particular timeslot might only contain high-priority data samples. In this case, the high-priority data samples must be power-scaled if the total power otherwise exceeds the capability of the radio unit.

In some embodiments, the combining and the power adjustment are performed in the radio unit 240. Then, the data samples as well as information identifying which of the data samples that are high-priority data samples and which of the data samples that are low-priority data samples need to be conveyed to the radio unit 240 from the digital baseband unit 250.

In this respect, there might be different ways to convey the information identifying which of the data samples that are high-priority data samples and which of the data samples that are low-priority data samples from the digital baseband unit 250 to the radio unit 240. In some embodiments, the low-priority indicator and the high-priority indicator are provided to the radio unit 240 from the digital baseband unit 250 over the CPRI interface. Thereby, for different timeslots, carriers, radio branches, or ports, there might be different number of streams of data samples that contain information conveyed to the radio unit via the CPRI interface. In some examples a new information field is added to the CPRI frame structure. The new information field could use one or more reserved information fields that exist in the CPRI frame structure.

In other embodiments, the combining and the power adjustment are performed in the digital baseband unit 250. This implies that the radio overbooking is performed in the digital baseband unit 250 and therefore that power adjustment is not needed in the radio unit. Hence, the high-priority data samples and the low-priority data samples for different carriers, radio branches, or ports, might be combined before they are sent to the radio unit. In this case the radio unit receives one signal per carrier, and radio branch or port (and antenna), and the combining is then done per antenna and per carrier.

The radio overbooking power adjustment can operate on different levels, for example, per carrier, per radio branch, or per port. In particular, according to some embodiments, the high-priority data samples and the low-priority data samples are obtained for a carrier or radio branch or port, and all the data samples are combined per radio branch or port for the stream of data samples to be transmitted. As an illustrative example, consider a 4-branch radio unit with a maximum total output of max 60 W. Assume further that the maximum total output is 15 W per radio branch (for example by each radio branch having a 15 W power amplifier). Assume further that the radio unit and the digital baseband unit are configured with two carriers, each with 40 W and 20 MHz bandwidth, i.e. 2 W/MHz PSD. Evidently, 40+40>60 [W]. Hence, assuming a scheduling that leads to heavy PRB utilization on both carriers, then the signal to be conveyed to the antenna unit needs to be scaled down. Assume that the power adjustment instead is performed per radio branch, as in FIG. 4. In this case, for the reference network node 20b, the total signal as scaled per radio branch can be formed as

$${s}_{p}^{b} = {β}_{p} ( {s}_{1 p} + {s}_{2 p} ) ,$$

where sₖₚ is the data stream associated with carrier k and radio branch p, and where Bp ensures that the total power does not exceed 15 W per radio branch p. Further, in similar way, the power adjustment per radio branch, as in FIG. 4(b), can according to embodiments be realized by forming

$${s}_{p}^{b} = {α}_{p} ( {s}_{1 p} + {s}_{2 p} ) + {{s}^{′}}_{1 p} + {{s}^{′}}_{2 p} ,$$

where αₚ ensures that the total power does not exceed 15 W for radio branch p, where sₖₚ is the low-priority data stream associated with carrier k and radio branch p, and where s′ₖₚ is the high-priority data stream associated with carrier k and radio branch p.

Further, during the combining, the high-priority data samples and the low-priority data samples obtained for a carrier might be linearly combined with further high-priority data samples and further low-priority data samples obtained for a further carrier.

In some aspects, the radio unit implements also other further power adjustments techniques than the radio power overbooking considered here. For example, if the radio unit becomes overheated, then the power needs to be scaled down. This kind of other further scaling could either ignore or take into account information regarding high-priority data samples or low-priority data samples, depending on implementation. Hence, in some embodiments, further power adjustment is applied to the stream of data samples in the radio unit, and the further power adjustment is either independent from, or dependent on, the power adjustment as applied for the stream of data samples to meet the power budget.

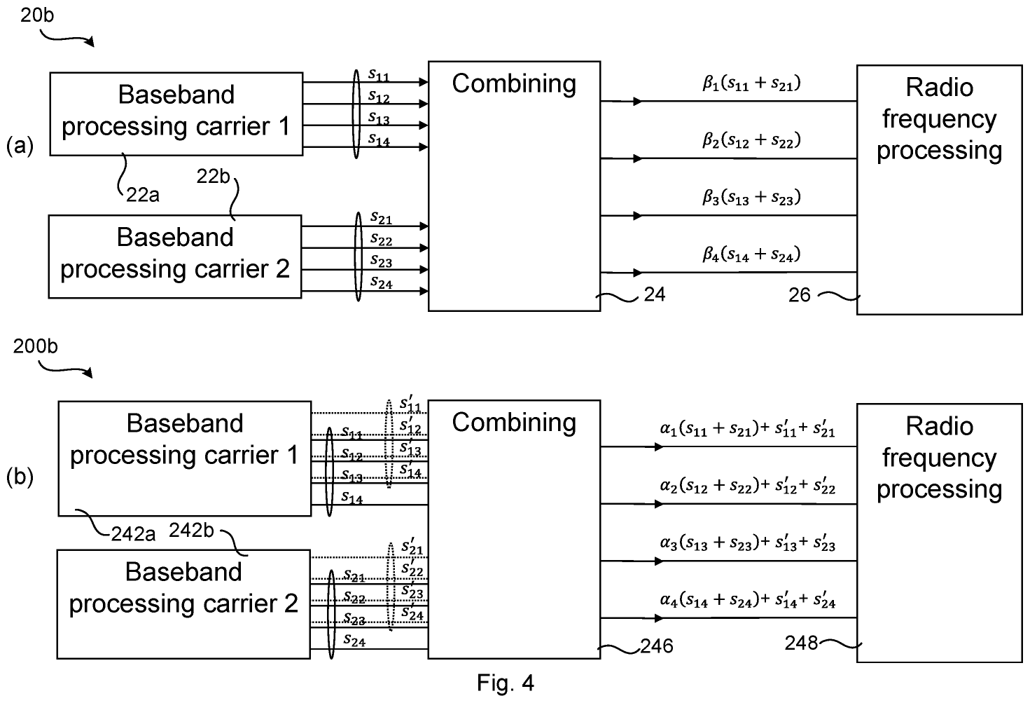

Reference is next made to FIG. 5 which illustrates a time/frequency grid and a separation into high and low priority signals according to an embodiment. In more detail, in FIG. 5 is illustrated how subcarriers for the orthogonal frequency-division multiplexing (OFDM) symbol at index i in a time/frequency grid 500 are partitioned into one stream of high-priority data samples 510 and one stream of low-priority data samples 520. In the example of FIG. 5, the high-priority data samples represent a synchronization signal block (SSB) signal that occupies three physical resource blocks (PRBs) in the ODFM symbol and the low-priority data samples represent a physical downlink shared channel (PDSCH) signal that occupies five physical resource blocks in the ODFM symbol. Once the PRBs 530 for the high-priority data samples have been extracted, they passed through an OFDM modulator 550 and a cyclic prefix (CP) is added to form one time-domain OFDM symbol for the high-priority data samples. Likewise, once the PRBs 540 for the low-priority data samples have been extracted, they passed through an OFDM modulator 560 and a CP is added to form one time-domain OFDM symbol for the low-priority data samples. If this is performed in the digital baseband unit, the streams with associated priorities are then sent to the radio unit over the CPRI interface where the power adjustment then is applied as disclosed above. In FIG. 5 is thus shown how two streams per carrier (and antenna port) with associated priorities are generated (or extracted). This functionality might be implemented, in, or in relation to, the OFDM modulators. As illustrated, one OFDM symbol is, before the OFDM modulators, split into two different sets according to the priorities the PRBs carry. Each set is then separately OFDM modulated into a respective stream. The control mechanism that decides which resource elements to map to low or high prioritized streams can be realized in different ways. For example, the mapping rules can be hardcoded, decided via higher-layer configuration messages, or dynamically decided by means of, e.g. scheduling or radio resource management (RRM) control messages.

One particular embodiment of a method for enabling a stream of data samples to meet a power budget as performed by the network node 200a, 200b will now be disclosed with reference to the flowchart of FIG. 6.
S201: The radio unit is configured with radio overbooking. In addition, the radio unit and the digital baseband unit are configured with prioritized radio overbooking as disclosed above.
S202: The digital baseband unit schedules different signals and channels on the resource elements in each timeslot, separately for each carrier.
S203: Based on configured priority rules, etc., the digital baseband unit determines for each timeslot and carrier which resource elements in time and frequency that should be mapped to the high-priority data samples and low-priority data samples. In addition, control information about the priorities and possibly the presence of different data streams may be conveyed over the CPRI interface to the radio unit.
S204: The radio unit receives the high-priority data samples, low-priority data samples for each carrier and the associated control information over the CPRI interface, and reads the control information. The radio unit uses the associated control information to deduce scaling factors to be applied to the data samples (at least to the low-priority data samples) in accordance with a maximum power threshold for the stream of data samples to meet a power budget (i.e., so that the total power available in the radio unit is not exceeded).
S205: The radio unit combines the high-priority data samples and low-priority data samples and performs radio overbooking with a power adjustment procedure. In the power adjustment procedure the radio unit takes the priorities of the different high-priority data samples and low-priority data samples into consideration, as defined by the scaling factors, and for each antenna branch forms a signal that is to be transmitted.

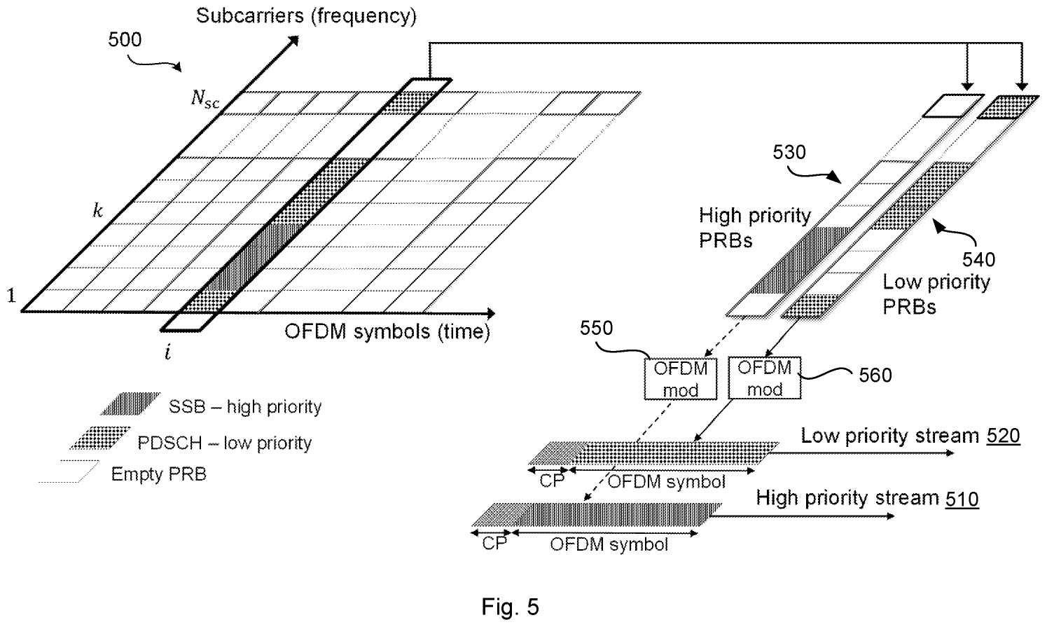

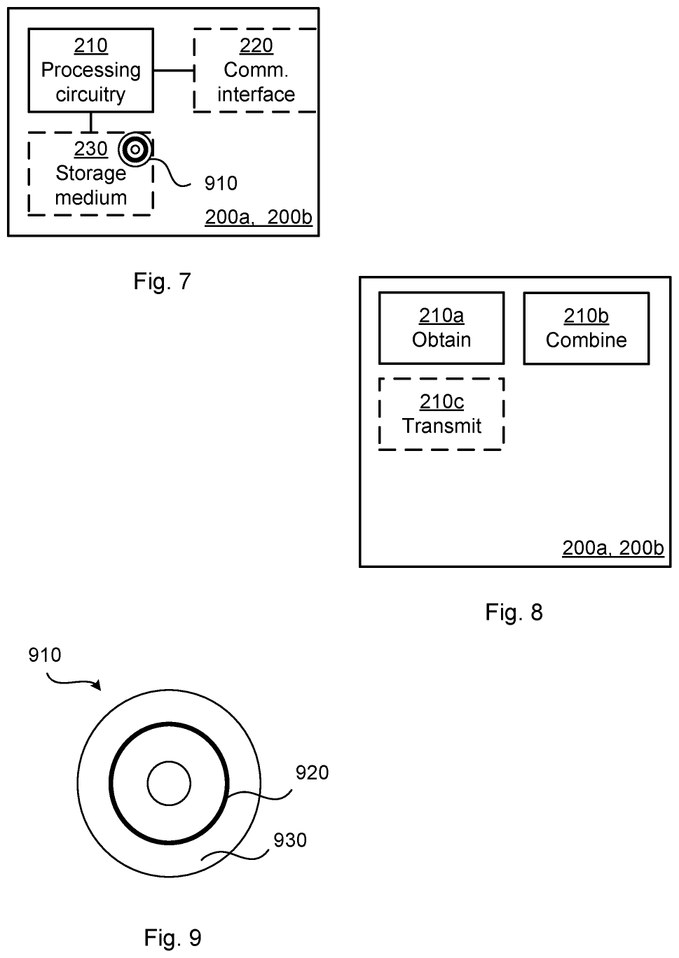

FIG. 7 schematically illustrates, in terms of a number of functional units, the components of a network node 200a, 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200a, 200b to perform a set of operations, or steps, as disclosed above. For example, the storage medium 230 may store the set of operations, and the processing circuitry 210 may be configured to retrieve the set of operations from the storage medium 230 to cause the network node 200a, 200b to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200a, 200b may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the network node 200a, 200b e.g. by sending data and control signals to the communications interface 220 and the storage medium 230, by receiving data and reports from the communications interface 220, and by retrieving data and instructions from the storage medium 230. Other components, as well as the related functionality, of the network node 200a, 200b are omitted in order not to obscure the concepts presented herein.

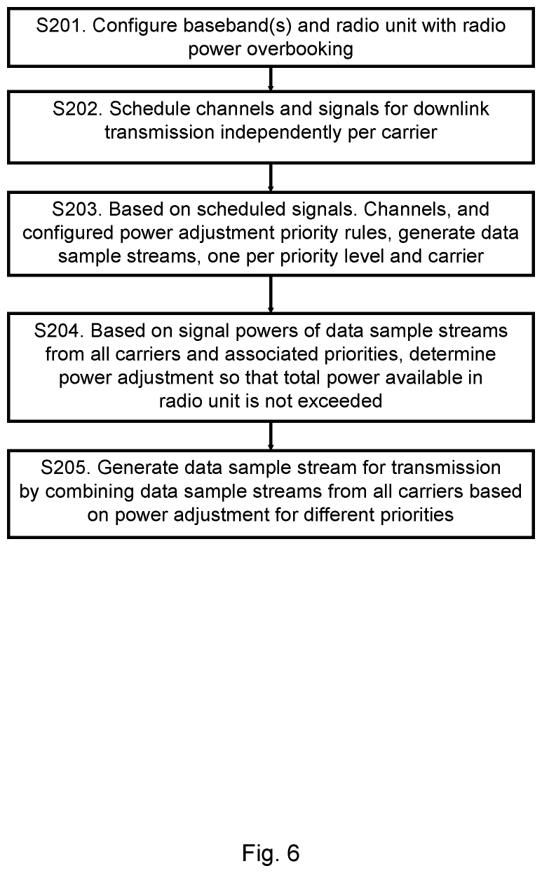

FIG. 8 schematically illustrates, in terms of a number of functional modules, the components of a network node 200a, 200b according to an embodiment. The network node 200a, 200b of FIG. 8 comprises a number of functional modules; an obtain module 210a configured to perform step S102, and a combine module 210b configured to perform step S104. The network node 200a, 200b of FIG. 8 may further comprise a number of optional functional modules, such as a transmit module 210c configured to perform step S106. In general terms, each functional module 210a: 210c may in one embodiment be implemented only in hardware and in another embodiment with the help of software, i.e., the latter embodiment having computer program instructions stored on the storage medium 230 which when run on the processing circuitry makes the network node 200a, 200b perform the corresponding steps mentioned above in conjunction with FIG. 10. It should also be mentioned that even though the modules correspond to parts of a computer program, they do not need to be separate modules therein, but the way in which they are implemented in software is dependent on the programming language used. Preferably, one or more or all functional modules 210a:210c may be implemented by the processing circuitry 210, possibly in cooperation with the communications interface 220 and/or the storage medium 230. The processing circuitry 210 may thus be configured to from the storage medium 230 fetch instructions as provided by a functional module 210a:210c and to execute these instructions, thereby performing any steps as disclosed herein.

The network node 200a, 200b may be provided as a standalone device or as a part of at least one further device. For example, the network node 200a, 200b may be provided in a node of the radio access network or in a node of the core network. Alternatively, functionality of the network node 200a, 200b may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time.

Thus, a first portion of the instructions performed by the network node 200a, 200b may be executed in a first device, and a second portion of the of the instructions performed by the network node 200a, 200b may be executed in a second device; the herein disclosed embodiments are not limited to any particular number of devices on which the instructions performed by the network node 200a, 200b may be executed. Hence, the methods according to the herein disclosed embodiments are suitable to be performed by a network node 200a, 200b residing in a cloud computational environment. Therefore, although a single processing circuitry 210 is illustrated in FIG. 7 the processing circuitry 210 may be distributed among a plurality of devices, or nodes. The same applies to the functional modules 210a: 210c of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for processing a stream of data samples to meet a power budget, the method being performed by a network node, the method comprising:
obtaining high-priority data samples and low-priority data samples, wherein the high-priority data samples have higher priority than the low-priority data samples; and
combining all the data samples into the stream of data samples to be transmitted, wherein power adjustment is applied to at least some of the data samples in accordance with a maximum power threshold for the stream of data samples to meet the power budget, wherein the power adjustment applied per data sample depends on whether the data sample is a high-priority data sample or a low-priority data sample, and wherein, according to the power adjustment, the low-priority data samples are allocated lower transmission power than the high-priority data samples.

2. The method according to claim 1, wherein the power adjustment is applied by:
applying power reduction to the low-priority data samples and/or applying power increase to the high-priority data samples,
combining all the data samples to the stream of data samples, and
adjusting transmission power of the stream of data samples in accordance with the maximum power threshold.

3. The method according to claim 1, wherein the power adjustment is applied by:
associating the low-priority data samples with a low-priority indicator and/or associating the high-priority data samples with a high-priority indicator,
combining all the data samples to the stream of data samples, and
adjusting transmission power of the stream of data samples in accordance with the maximum power threshold, wherein the low-priority indicator impacts adjusting the transmission power of the low-priority data samples, and wherein the high-priority indicator impacts adjusting the transmission power of the high-priority data samples.

4. The method according to claim 3, wherein the low-priority indicator and the high-priority indicator are provided as weight factors or scaling factors.

5. The method according to claim 1, wherein, according to the power adjustment, the transmission power of the low-priority data samples is either adjusted independent from, or relative to, adjustment of the transmission power of the high-priority data samples.

6. The method according to claim 1, wherein, according to the power adjustment, the transmission power of the low-priority data samples is at most reduced to a predetermined threshold value, and wherein also the transmission power of the high-priority data samples is reduced for the stream of data samples to meet the power budget

7. The method according to claim 1, wherein the network node comprises a radio unit, wherein further power adjustment is applied to the stream of data samples in the radio unit, and wherein the further power adjustment is either independent from, or dependent on, the power adjustment as applied for the stream of data samples to meet the power budget.

8. The method according to claim 1, wherein the network node comprises a radio unit, and wherein the combining and the power adjustment are performed in the radio unit.

9. The method according to claim 3, wherein the network node further comprises a digital baseband unit, and wherein the low-priority indicator and the high-priority indicator are provided to the radio unit from the digital baseband unit over a Common Public Radio Interface.

10. The method according to claim 1, wherein the network node comprises a digital baseband unit, and wherein the combining and the power adjustment are performed in the digital baseband unit.

11. The method according to claim 1, wherein also intermediate-priority data samples are obtained, wherein the intermediate-priority data samples are combined into the stream of data samples to be transmitted, wherein the intermediate-priority data samples have lower priority than the high-priority data samples but have higher priority than the low-priority data samples, and wherein, according to the power adjustment, the intermediate-priority data samples are allocated lower transmission power than the high-priority data samples but higher transmission power than the low-priority data samples.

12. The method according to claim 1, wherein the high-priority data samples represent a reference signal, such as a reference signal used for mobility measurements, or a control signal, and wherein the low-priority data samples represent a user data signal.

13. The method according to claim 1, wherein the high-priority data samples and the low-priority data samples are obtained for a carrier or radio branch or port, and wherein all the data samples are combined per carrier or radio branch or port for the stream of data samples to be transmitted.

14. The method according to claim 13, wherein, during the combining, the high-priority data samples and the low-priority data samples obtained for one carrier are linearly combined with further high-priority data samples and further low-priority data samples obtained for a further carrier.

15. The method according to claim 1, wherein the high-priority data samples and the low-priority data samples are obtained per timeslot, wherein all the data samples are combined per timeslot to the stream of data samples to be transmitted.

16. The method according to claim 15, wherein, according to the power adjustment, how much power adjustment that is applied per data sample is either absolute over time or adapted per timeslot.

17. (canceled)

18. A network node for processing a stream of data samples to meet a power budget, the network node comprising processing circuitry, the processing circuitry being configured to cause the network node to:
obtain high-priority data samples and low-priority data samples, wherein the high-priority data samples have higher priority than the low-priority data samples; and
combine all the data samples into the stream of data samples to be transmitted, wherein power adjustment is applied to at least some of the data samples in accordance with a maximum power threshold for the stream of data samples to meet the power budget, wherein the power adjustment applied per data sample depends on whether the data sample is a high-priority data sample or a low-priority data sample, and wherein, according to the power adjustment, the low-priority data samples are allocated lower transmission power than the high-priority data samples.

19. (canceled)

20. The network node according to claim 18, wherein the power adjustment is applied by the processing circuitry:
applying power reduction to the low-priority data samples and/or applying power increase
to the high-priority data samples,
combining all the data samples to the stream of data samples, and
adjusting transmission power of the stream of data samples in accordance with the maximum power threshold

21. A computer program product for processing a stream of data samples to meet a power budget, the computer program product comprising a non-transitory computer readable medium storing computer code which, when run on processing circuitry of a network node, causes the network node to:
obtain high-priority data samples and low-priority data samples, wherein the high-priority data samples have higher priority than the low-priority data samples; and
combine all the data samples into the stream of data samples to be transmitted, wherein power adjustment is applied to at least some of the data samples in accordance with a maximum power threshold for the stream of data samples to meet the power budget, wherein the power adjustment applied per data sample depends on whether the data sample is a high-priority data sample or a low-priority data sample, and wherein, according to the power adjustment, the low-priority data samples are allocated lower transmission power than the high-priority data samples.

22. (canceled)
